(19) United States
(12) Patent Application Publication
(10) Pub. No.: US 2015/0310979 A1
(43) Pub. Date: Oct. 29, 2015

(54) BUILDING-BLOCK-COMBINED-TYPE HIGH POWER TRANSFORMER

(71) Applicant: Chang-Yu Pan, New Taipei City (TW)

(72) Inventor: Chang-Yu Pan, New Taipei City (TW)

(21) Appl. No.: 14/485,670

(22) Filed: Sep. 13, 2014

Related U.S. Application Data
(63) Continuation-in-part of application No. 14/264,487, filed on Apr. 29, 2014, now abandoned.

(51) Int. Cl. H01F 27/24; H01F 27/28

(52) U.S. Cl. CPC H01F 27/24; H01F 27/28

(57) ABSTRACT

A building-block-combined-type high power transformer includes a plurality of identical iron core bodies, a plurality of conductive plates and a plurality of insulating plates. Each iron core body is a polygon in shape and is provided with an outer side wing and an inner side wing extending in parallel thereon, and an open channel between the outer and inner side wings. The side(s) of the iron core bodies closer to the inner side wing are partially in contact with one another to form a larger iron core structure, and the inner side wings are connected together to form a combined portion. The plurality of conductive plates are stacked in the open channels of the iron core bodies. Each conductive plate includes an opening into which the combined portion is inserted, and each opening includes a guided channel for external connection. Each guided channel is formed with a pin on either side thereof. One insulating plate is sandwiched between two conductive plates. As such, a high power transformer is formed.

This is a continuation in part application of inventor's prior patent application Ser. No. 14/264,487 filed on Apr. 29, 2014.

### BACKGROUND OF THE INVENTION

1. Field of the Invention

The invention relates to building-block-combined-type high power transformers, and more particularly, to high power transformers in various high power applications formed by several iron cores of the same type assembled in various different combinations.

2. Description of the Prior Art

In the field of high power transformers, conventional winding structures formed by winding wires (enamelled wires) are used. In order to accommodate the requirements of larger output currents, the outer diameters of the wires have to be increased to improve the current load they can withstand. However, these wires with circular cross sections when wound into windings will inevitably leave large gaps between the loops (turns), such that the overall volume of the transformers cannot be reduced, creating limitations and shortcomings in their applications.

Thus, in order to reduce the gap between the turns of the windings, various winding structures formed by non-circular cross sections are rapidly gaining popularity. For example, in U.S. Patent Application Publication No. 2004/0108929 titled “TRANSFORMER”, a “transformer 10” structure formed by disposing various flat-type “windings 10p1, 10p2 and 10p3” and “windings 10s1 and 10s2 ” in “cores 21 and 22” is disclosed. However, in the disclosed embodiment, there is only one way to assembling and implement the “cores 21 and 22” and the “windings 10p1, 10p2 and 10p3” and “windings 10s1 and 10s2”, that is, the “cores 21 and 22” cannot be assembled in other arrangements or combinations to accommodate different specification requirements and application aspects, so there are still limitations in actual implementations.

Another U.S. Pat. No. 7,091,817 titled “PLANAR TRANSFORMER COMPRISING PLUG-IN SECONDARY WINDINGS” discloses a transformer structure composed of two planar “winding sheets 2” and 2 E-shaped “ferrite core halves 1a and 1b”. Similarly, in this disclosure, there is only one way of assembling and implementing the “ferrite core halves 1a and 1b” and the “winding sheets 2”; the “ferrite core halves 1a and 1b” cannot be assembled in other arrangements or combinations to accommodate different specification requirements and application aspects, so there are similar limitations in terms of their actual implementations.

In view of the abovementioned shortcomings of the prior-art transformer structures, the present invention is proposed to address these shortcomings.

### SUMMARY OF THE INVENTION

One main objective of the present invention is to provide a building-block-combined-type high power transformer which can be assembled to satisfy different transformer specifications by combing and assembling several smaller iron core bodies of the same type into a larger iron core structure suitable for higher power applications in conjunction with appropriately designed conductive plates and insulating plates as the required windings. The present invention can be applied to various different applications to satisfy different requirements while reducing product development cost and production cost and improving competitiveness of the products.

In order to achieve the above objective and other effects, the following technical aspects are proposed by the present invention: a plurality of identical iron core bodies, each being a polygon in shape and provided with an outer side wing and an inner side wing extending in parallel thereon, and an open channel between the outer and inner side wings, a side of each iron core body closer to the inner side wing being partially in contact with said side of another iron core body, such that the inner side wings are connected to form a combined portion; a plurality of conductive plates stacked in the open channels of the iron core bodies, each conductive plate including an opening into which the combined portion is inserted, each opening including a guided channel for external connection, and each guided channel being formed with a pin on either side thereof; and a plurality of insulating plates disposed in the open channels of the iron core bodies, each insulating plate including a through hole into which the combined portion is inserted, and an insulating plate being disposed between two conductive plates.

The accomplishment of this and other objectives of the invention will become apparent from the following description and its accompanying drawings of which:

### BRIEF DESCRIPTION OF THE DRAWINGS

FIG. 1A is an isometric view of a preferred embodiment of an iron core body of the invention.

FIG. 1B is a top planar view of a preferred embodiment of an iron core body of the invention.

FIG. 2A is an exploded view of a first preferred embodiment of the invention.

FIG. 2B is an isometric view of the assembled structure of the first preferred embodiment of the invention.

FIG. 3A is an exploded view of a second preferred embodiment of the invention.

FIG. 3B is an isometric view of the assembled structure of the second preferred embodiment of the invention.

### DETAILED DESCRIPTION OF THE PREFERRED EMBODIMENT

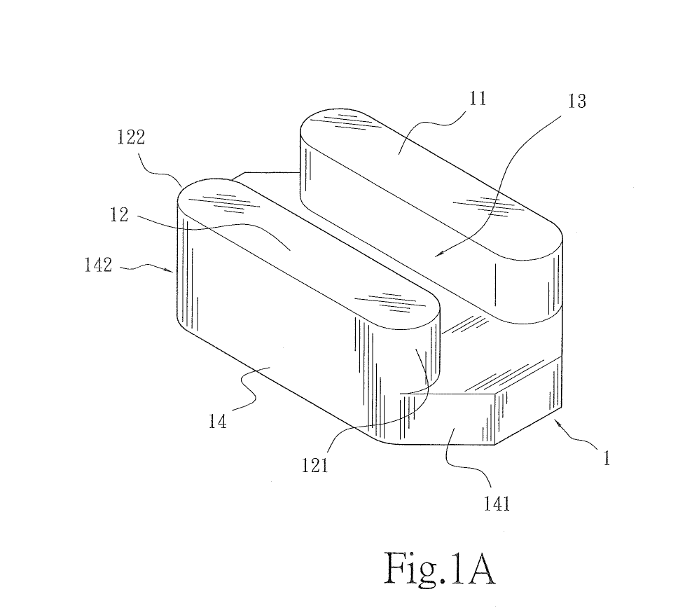

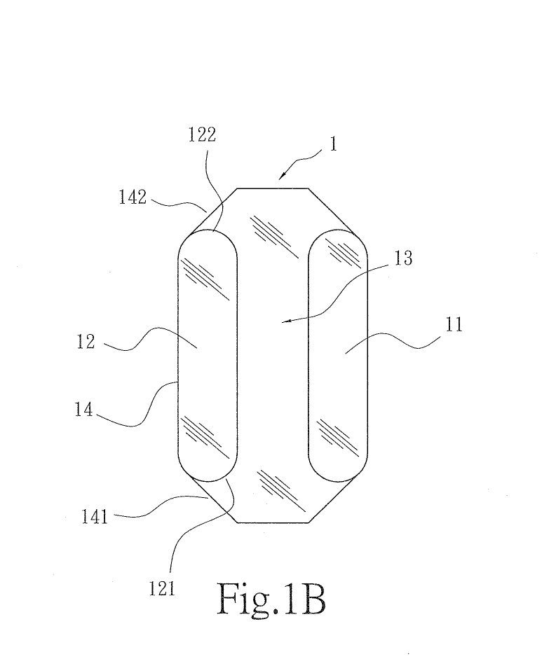

As shown in FIGS. 1A and 1B, the structure of an iron core body 1 applicable to the present invention is substantially a flat polygonal body (in actual implementations, the iron core body 1 is preferable in the shape of an octagon). An outer side wing 11 and an inner side wing 12 extend in parallel on two opposite sides of the iron core body 1, and an open channel 13 is provided between the outer and inner side wings 11 and 12. The side of the iron core body 1 closer to a side edge of the inner side wing 12 is defined as a first side 14, and two sides extending obliquely from either end of the first side 14 are defined as a second side 141 and a third side 142, respectively (i.e. another two side edges of the iron core body 1).

In one possible implementation, the iron core body 1 can be an elongated octagonal body with the outer and inner side wings 11 and 12 provided on the two opposite longer sides of the elongated octagon in equal lengths. The length of the inner side wing 12 is equal to that of the first side 14, and the two ends of the inner side wing 12 have rounded edges 121 and 122, respectively, which are partially flushed with the second and third sides 141 and 142, respectively.

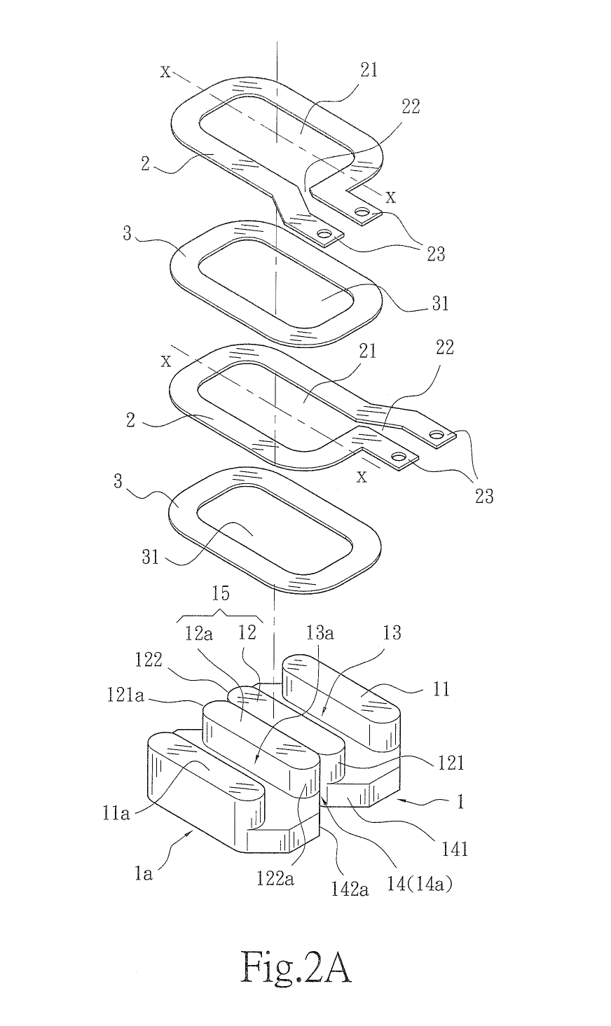

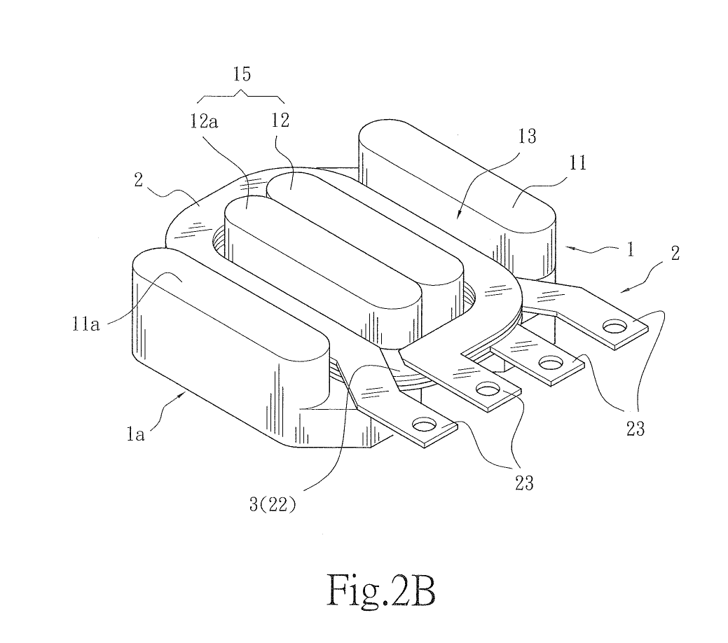

As can been seen in FIGS. 2A and 2B, an implementation disclosed in accordance with a first preferred embodiment of the present invention includes: two identical iron core bodies 1 and 1a, a plurality of conductive plates 2, and a plurality of insulating plates 3; wherein an outer side wing 11a, an inner side wing 12a, rounded edges 121a and 122a, an open channel 13a, a first side 14a, a second side 141a (not shown), and a third side 142a are provided on the iron core body la, which respectively correspond to an outer side wing 11, an inner side wing 12, rounded edges 121 and 122, an open channel 13, a first side 14, a second side 141, and a third side 142 on the iron core body 1.

The two iron core bodies 1 and 1a are brought together with the first sides 14 and 14a abutting each other, such that the two inner side wings 12 and 12a are juxtaposed to form a combined portion 15.

Each of the conductive plates 2 is provided with an opening 21 at the center thereof, and into which the combined portion 15 can be inserted. A guided channel 22 is provided at a side of the opening 21 for external connection. The guided channel 22 has a pin 23 on either side thereof. When assembled, the plurality of conductive plates 2 are stacked inside the open channels 13 and 13a of the iron core bodies 1 and 1a to be used as the windings of a transformer with their respective two pins 23 extending out from the iron core bodies 1 and 1a.

In one possible implementation, the plurality of conductive plates 2 can be stacked in the open channels 13 and 13a in an “alternating front and back” arrangement (that is, an underlying conductive plate is essentially the same as the overlying conductive plate except that it is flipped by 180 degrees with respect to an x axis that is parallel to the first side 14). Accordingly, the pins 23 of each plate 2 are staggered outwardly on different locations.

Each of the insulating plates 3 is oval-ring-shaped with a through hole 31 provided in the center thereof. The combined portion 15 can be inserted into the through hole 31. When assembled, one insulating plate 3 is sandwiched between two conductive plates 2 to form effective insulating between the layers.

In the structure above, two identical iron core bodies 1 and 1a are combined to form a larger iron core structure, combined with the planar windings formed by the staggered and stacked conductive plates 2 (instead of coils formed by twisting enamelled wires), thus saving space and reducing eddy current losses, making it particularly suitable for high power transformer applications with large wattages (3000 watts or larger).

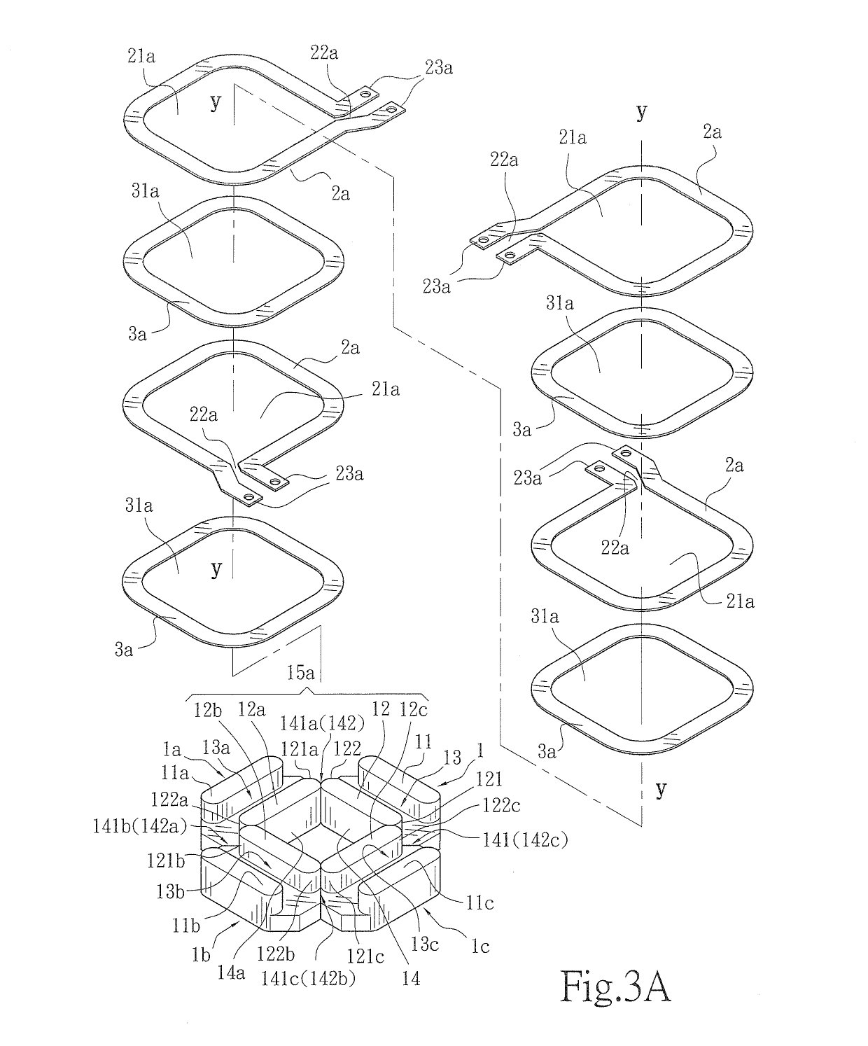

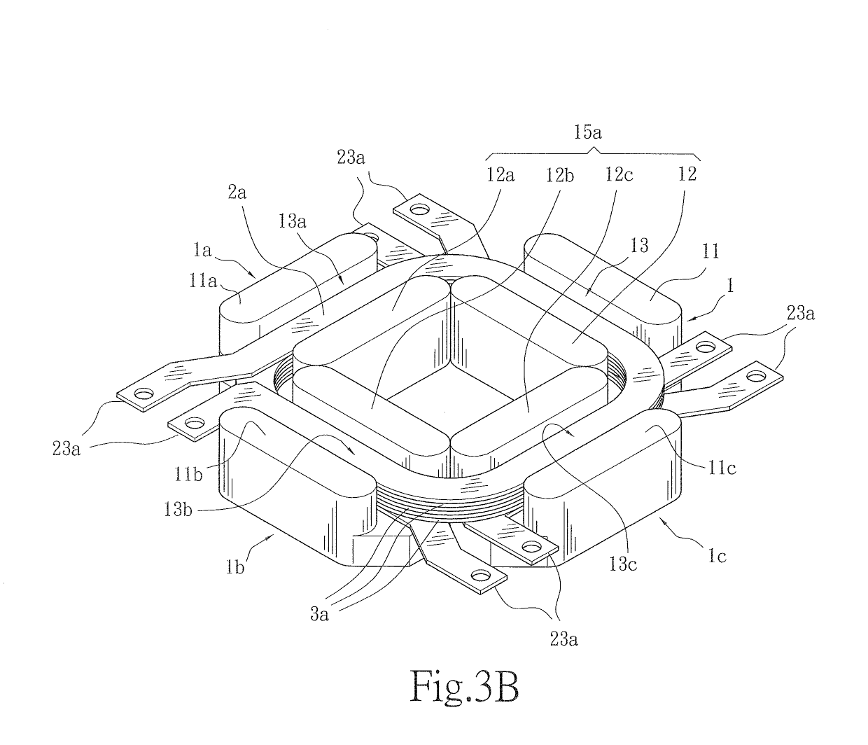

As can been seen in FIGS. 3A and 3B, an implementation disclosed by a second preferred embodiment of the present invention includes: identical iron core bodies 1, 1a, 1b and 1c, a plurality of conductive plates 2a, and a plurality of insulating plates 3a; wherein outer side wings 11a, 11b and 11c, inner side wings 12a, 12b and 12c, rounded edges 121a, 122a, 121b, 122b, 121c and 122c, open channels 13a, 13b and 13c, first sides 14a, 14b and 14c (14b and 14c not shown), second sides 141a, 141b and 141c, and third sides 142a, 142b and 142c are respectively provided on the iron core bodies 1a, 1b and 1c, which correspond to an outer side wing 11, an inner side wing 12, rounded edges 121 and 122, an open channel 13, a first side 14, a second side 141, and a third side 142 on the iron core body 1, respectively.

The iron core bodies 1, 1a, 1b and 1c are arranged in a loop, wherein the second sides 141, 141a, 141b and 141c abut the adjacent third sides 142, 142a, 142b and 142c, respectively, such that the inner side wings 12, 12a, 12b and 12c are connected in a loop to form a combined portion 15a.

Each of the conductive plates 2a is provided with an opening 21a at the center thereof, and into which the combined portion 15a can be inserted. A guided channel 22a is provided at a side of the opening 21a for external connection. The guided channel 22a has a pin 23a on either side thereof. When assembled, the plurality of conductive plates 2a are stacked inside the open channels 13, 13a, 13b and 13c of the iron core bodies 1, 1a, 1b and 1c to be used as the windings of a transformer with their respective two pins 23 extending out from the iron core bodies 1, 1a, 1b and 1c.

In one possible implementation, a y axis is defined along the direction in which the plurality of conductive plates 2a are stacked, and each conductive plate 2 is stacked in the open channels 13, 13a, 13b and 13c in a “90-degree-rotation” arrangement around the y axis. Accordingly, the pins 23 of each plate 2 are staggered outwardly on different locations.

Each of the insulating plates 3a is oval-ring-shaped with a through hole 31a provided in the center thereof. The combined portion 15a can be inserted into the through hole 31a. When assembled, one insulating plate 3a is disposed between two conductive plates 2a to form effective insulating between the layers.

In conclusion, the building-block-combined-type high power transformer of the invention is capable of being applied to a wide range of applications, reducing production cost and improving the competitiveness of the industry in the field, thereby, is possessing the patentability of having the non-obviousness subject matter and the applicability in the industry in the field. It should be noted that the descriptions above are merely presented as illustrations of the preferred embodiments of the present invention, and that various modifications, variations and equivalent substitutions can be made to the invention without departing from the scope or spirit of the invention. In view of the foregoing description, it is intended that all such modifications and variations fall within the scope of the following appended claims and their equivalents.

What is claimed is:

1. A building-block-combined-type high power transformer, comprising:
a plurality of identical iron core bodies, each being a polygon in shape and provided with an outer side wing and an inner side wing extending in parallel thereon, and an open channel between the outer and inner side wings, a side of each iron core body closer to the inner side wing being partially in contact with said side of another iron core body, such that the inner side wings are connected to form a combined portion;
a plurality of conductive plates stacked in the open channels of the iron core bodies, each conductive plate including an opening into which the combined portion is inserted, each opening including a guided channel for external connection, and each guided channel being formed with a pin on either side thereof; and
a plurality of insulating plates disposed in the open channels of the iron core bodies, each insulating plate including a through hole into which the combined portion is inserted, and an insulating plate being disposed between two conductive plates.

2. The building-block-combined-type high power transformer as claimed in claim 1, wherein each iron core body has a first side closer to a side edge of the inner side wing, and second and third sides obliquely extending from either end of the first side, two iron core bodies abut one another along their first sides, such that the inner side wings adjoin each other side-by-side to form the combined portion.

3. The building-block-combined-type high power transformer as claimed in claim 1, wherein each iron core body has a first side closer to a side edge of the inner side wing, and second and third sides obliquely extending from either end of the first side, the second side of each of the plurality of iron core bodies abut the third side of an adjacent iron core body, such that the plurality of inner side wings connect with each other to form the combined portion.

4. The building-block-combined-type high power transformer as claimed in claim 1, wherein the length of the inner side wing of each iron core body is equal to that of the first side, and the inner side wing is aligned in conformity with the edge of the first side, and both ends of the inner side wing have rounded edges which are partially flushed with the second and third sides.

5. The building-block-combined-type high power transformer as claimed in claim 1, wherein the outer and inner side wings of each iron core body are of equal lengths.

6. The building-block-combined-type high power transformer as claimed in claim 1, wherein each iron core body is an octagon in shape.
